(19) United States
(12) Patent Application Publication
(10) Pub. No.: US 2016/0292946 A1
(43) Pub. Date: Oct. 6, 2016

(54) METHOD AND APPARATUS FOR COLLECTING STATISTICS ON NETWORK INFORMATION

(71) Applicant: TENCENT TECHNOLOGY (SHENZHEN) COMPANY LIMITED, Shenzhen (CN)

(72) Inventors: Xiaokang Ran, Shenzhen (CN); Chang Liu, Shenzhen (CN); Mengjie Wang, Shenzhen (CN)

(21) Appl. No.: 15/177,536

(22) Filed: Jun. 9, 2016

Related U.S. Application Data
(63) Continuation of application No. PCT/CN2015/075004, filed on Mar. 25, 2015.

(30) Foreign Application Priority Data
Mar. 27, 2014 (CN) 201410120042.9

(51) Int. Cl. G07C 13/00; G06F 3/0484; G06F 3/0481; G06Q 30/02

(52) U.S. Cl. CPC G07C 13/00; G06Q 30/0203; G06F 3/04842; G06F 3/04817

(57) ABSTRACT

A method and an apparatus for collecting statistics on network information are provided. The method includes: displaying multiple pieces of image information and voting indication information; and when receiving a first selection instruction corresponding to first image information, sending a voting request carrying an identifier of the first image information to a server, so that the server updates, according to the identifier carried in the voting request and of the first image information, stored information about a vote quantity corresponding to the image information. By using the present disclosure, accuracy of statistics collection on network information can be improved.

### CROSS REFERENCE TO RELATED APPLICATIONS

This is a continuation application of International Patent Application No. PCT/CN2015/075004, filed on Mar. 25, 2015, which claims priority to Chinese Patent Application No. 201410120042.9 filed on Mar. 27, 2014, the disclosures of which are incorporated by reference herein in their entirety.

### FIELD OF THE TECHNOLOGY

The present disclosure relates to the field of Internet technologies, and in particular, to a method and an apparatus for collecting statistics on network information.

### BACKGROUND OF THE DISCLOSURE

With the development of computer technologies and network technologies, Internet is rapidly popularized, and has become a very important part of daily work and life of people. Internet provides a user with very rich and practical network functions, and statistics collection on network information (or referred to as a network voting) is a normal network function.

A process of collecting statistics on network information generally is as follows: a user initiating voting uploads text information of questions for a network voting (which may be referred to as voting indication information) and answers for selection to a server; and the user performs selection after reading the text information of the questions and answers. In this case, a long time is consumed, and a time for collecting statistics on voting is easily delayed. Many users read quickly and roughly to increase a voting speed, and in this way, accuracy of a selected result is poor, thereby causing poor accuracy of statistics collection on network information.

### SUMMARY

In view of the above, embodiments of the present invention provide a method and an apparatus for collecting statistics on network information, so as to improve accuracy of statistics collection on network information.

In one aspect, a method for collecting statistics on network information is provided, including:

at a computing device having one or more processors and a memory storing programs executed by the one or more processors:

providing a display interface, to display multiple pieces of image information and voting indication information of each piece of the image information, each piece of the image information corresponding to one identifier; and receiving, on the display interface, a first selection instruction corresponding to first image information;

sending a voting request carrying an identifier of the first image information to a server; and

instructing, by using the voting request, the server to update, according to the identifier carried in the voting request and of the first image information, information that is stored in the server and about a vote quantity corresponding to the first image information.

In another aspect, an apparatus for collecting statistics on network information is provided, including:

one or more processors;

a memory; and

one or more program modules stored in the memory and executed by the one or more processors, the one or more program modules comprising:

a display module, configured to provide a display interface, display multiple pieces of image information and voting indication information, each piece of the image information corresponding to one identifier; and

a sending module, configured to receive a first selection instruction corresponding to first image information, send a voting request carrying an identifier of the first image information to a server, and instruct, by using the voting request, the server to update, according to the identifier carried in the voting request and of the first image information, information that is stored in the server and about a vote quantity corresponding to the first image information.

A non-transitory computer readable storage medium having stored therein one or more instructions, which, when executed by a computing device, cause the computing device to: providing a display interface, to display multiple pieces of image information and voting indication information of each piece of the image information, each piece of the image information corresponding to one identifier; and receiving, on the display interface, a first selection instruction corresponding to first image information; sending a voting request carrying an identifier of the first image information to a server; and instructing, by using the voting request, the server to update, according to the identifier carried in the voting request and of the first image information, information that is stored in the server and about a vote quantity corresponding to the first image information.

In the embodiments of the present invention, image information is used as an option for voting, and a user may acquire more information from an image through a short browse, so as to improve accuracy of a selection result, thereby improving accuracy of statistics collection on network information.

### BRIEF DESCRIPTION OF THE DRAWINGS

To describe the technical solutions in the embodiments of the present invention more clearly, the following briefly introduces the accompanying drawings required for describing the embodiments. Apparently, the accompanying drawings in the following descriptions show merely some embodiments of the present invention, and a person of ordinary skill in the art may still derive other drawings from the accompanying drawings without creative efforts.

FIG. 1 is a flowchart of a method for collecting statistics on network information according to an embodiment of the present invention;

FIG. 2 is a schematic diagram of interface display according to an embodiment of the present invention;

FIG. 3 is a schematic structural diagram of an apparatus for collecting statistics on network information according to an embodiment of the present invention; and

FIG. 4 is a schematic structural diagram of a terminal according to an embodiment of the present invention.

### DESCRIPTION OF EMBODIMENTS

In order to make the objectives, technical solutions and advantages of the present disclosure clearer, the embodiments of the present invention are described in detail in the following with reference to the accompanying drawings.

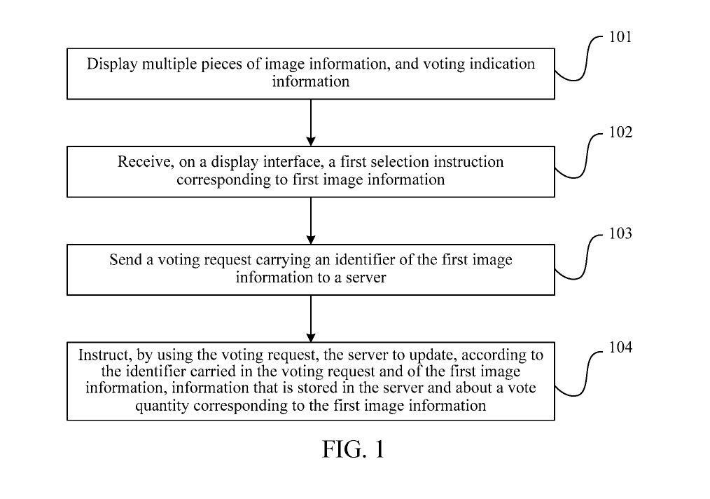

An embodiment of the present invention provides a method for collecting statistics on network information. As shown in FIG. 1, a process of the method may include the following steps:

Step 101: Provide a display interface, to display multiple pieces of image information and voting indication information of each piece of the image information, each piece of the image information corresponding to one identifier.

Step 102: Receive, on the display interface, the first selection instruction corresponding to the first image information.

Step 103: Send a voting request carrying an identifier of the first image information to a server.

Step 104: Instruct, by using the voting request, the server to update, according to the identifier carried in the voting request and of the first image information, information that is stored in the server and about a vote quantity corresponding to the first image information.

In this embodiment of the present invention, multiple pieces of image information, and voting indication information are displayed, and when a first selection instruction corresponding to first image information is received, a voting request carrying an identifier of the first image information is sent to a server, so that the server updates stored information about a vote quantity corresponding to the image information according to the identifier carried in the voting request and of the first image information. In this way, image information is used as an option for voting, and a user may acquire more information from an image through a short browse, so as to improve accuracy of a selection result, thereby improving accuracy of statistics collection on network information.

An embodiment of the present invention provides a method for collecting statistics on network information. This method is executed by a terminal. When the terminal is connected to Internet, the terminal may run an application program helping network voting, or may log in, by using a browser, to a website providing a network voting function.

Before the process shown in FIG. 1 is performed, the following processing may also be performed: a first terminal receives multiple pieces of image information and voting indication information that are sent by a server. Accordingly, processing on the server side may be: acquiring multiple pieces of the image information and the voting indication information; and sending the voting indication information and multiple pieces of the image information to the first terminal.

The image information may be a picture, an animation, a video, or the like. The voting indication information may be information used for indicating, to a user, a condition for selecting image information, for example, please select your favorite view, or, please select your favorite breakfast, or the like.

During implementation, the server may establish one or more network votings (in this embodiment of the present invention, it may be referred to as image voting or picture voting or the like), where the network voting may be initiated by a user to the server, or may be initiated by the server itself. The server may set the established network votings in a corresponding webpage, for example, all network votings may be set in a page used for displaying the network voting, or, a network voting initiated by an account may be set in a feed page of a friend account of the account according to a relationship between accounts. When receiving a page request sent by the first terminal, the server acquires data of the requested page. If the page includes network voting, the page data may include voting indication information and image information that correspond to the network voting, and the server sends the acquired page data to the first terminal.

The server may also acquire information about a vote quantity corresponding to each piece of image information, and send information about the vote quantity corresponding to each piece of image information, the voting indication information, and the image information to the first terminal.

The information about the vote quantity is used for reflecting information about a voting situation of network users for each piece of image information, where the information about the vote quantity may be a value of the vote quantity of the image information, or may be a percentage of the vote quantity of the image information in the total quantity of votes of multiple pieces of the image information. For example, the network voting includes four pictures, and vote quantities thereof are 20, 30, 15, and 35 respectively; therefore, information about the vote quantities may be 20, 30, 15, and 35, or may be 20%, 30%, 15%, and 35%.

The following describes in detail the process in FIG. 1 with reference to specific processing manners, and the content may be as follows:

Step 101: A first terminal displays multiple pieces of image information and voting indication information of each piece of the image information.

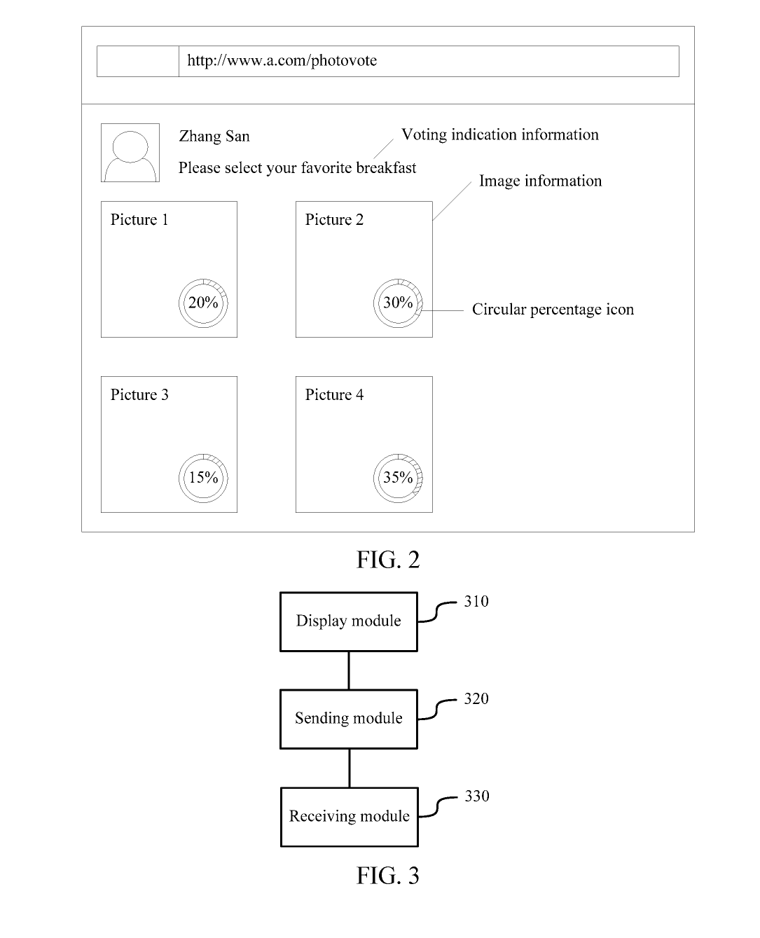

In this embodiment, when a user opens, at the first terminal, a webpage having picture voting, the first terminal sends a corresponding page request to a server, and receives page data returned by the server, where the page data includes voting indication information and multiple pieces of image information of the picture voting. The first terminal may load a corresponding webpage according to the received page data, display the voting indication information of the picture voting on the webpage, and display the image information below the voting indication information. As shown in FIG. 2, information, such as an account name or an avatar, related to an account initiating the picture voting may also be displayed accordingly.

The first terminal may also display a percentage of a vote quantity corresponding to each piece of the image information, and accordingly, the first terminal may receive information about the vote quantity that corresponds to each piece of the image information and is sent by the server. Further, processing of step 101 may be specifically as follows:

Step 1: Determine a percentage of the vote quantity corresponding to each piece of the image information according to the information about the vote quantity corresponding to each piece of the image information.

The information about the vote quantity may be a value of the vote quantity. The percentage of the vote quantity may be a percentage accounted for by a vote quantity of a piece of image information in the total quantity of votes of all image information.

During implementation, the first terminal may add the vote quantity of each piece of the image information, to obtain the total quantity of votes, and then divide the total quantity of votes by the vote quantity of each piece of the image information, to obtain a percentage of the vote quantity corresponding to each piece of the image information.

Step 2: Display the voting indication information and multiple pieces of the image information, and display the determined percentage of the vote quantity in correspondence to each piece of the image information.

During implementation, a percentage of the vote quantity corresponding to image information may be displayed on the image information (such as a picture), or may be displayed on an area near the image information. The percentage of the vote quantity may be displayed in the following manner:

As shown in FIG. 2, a circular percentage icon is set in each piece of displayed image information according to a corresponding percentage of a vote quantity, and the corresponding percentage of the vote quantity is displayed in the set percentage icon.

During implementation, for different browsers, different manners may be used to display the circular percentage icon. For example, for a browser supporting Cascading Style Sheet 3 (CSS3), a pattern provided by the browser may be used to generate a circular percentage icon, and the percentage of the vote quantity is entered on a corresponding interface provided by the browser; therefore, a circular percentage icon of a corresponding percentage may be generated. For another example, the browser supporting CSS3 may store different pictures to display circular percentage icons of different percentages, for example, 100 pictures are set for 1% to 100%. A corresponding percentage of a vote quantity may be displayed in the middle of a circular percentage icon.

Step 102: Receive, on the display interface, a first selection instruction corresponding to first image information.

The first image information may be any piece of image information in multiple pieces of the displayed image information. The first selection instruction is an instruction triggered when the user selects the first image information.

Specifically, processing of this step may be: when the first selection instruction triggered when a percentage icon corresponding to the first image information is clicked is received, sending a voting request carrying an identifier of the first image information to the server.

Step 103: The first terminal sends a voting request carrying an identifier of the first image information to the server, where the voting request is a request for voting on the image information.

Step 104: Instruct, by using the voting request, the server to update, according to the identifier carried in the voting request and of the first image information, information that is stored in the server and about a vote quantity corresponding to the first image information.

During implementation, after the user browses the image information (for example, a picture), the user may select one piece of image information to vote for it; in this case, the user may click a percentage icon displayed in the image information (that is, the first image information), and the first selection instruction is triggered and generated; besides, an animation effect of clicking may also be displayed, for example, an animation of first zooming in and then zooming out the percentage of the vote quantity displayed in the middle is displayed. After receiving the first selection instruction, the first terminal generates the voting request, adds the identifier of the first image information selected by the user to the voting request, and sends the voting request to the server. Meanwhile, after receiving the first selection instruction, the first terminal may update information about a vote quantity and a percentage of the vote quantity of image information according to the first image information selected by the user, and specifically, the first terminal may add one to the vote quantity of the first image information, and re-calculate the corresponding percentage of the vote quantity.

Accordingly, processing on the server side may be: receiving the voting request sent by the first terminal, where the voting request carries the identifier of the first image information; and updating the information about the vote quantity corresponding to the stored image information according to the identifier carried in the voting request and of the first image information.

During implementation, the server may add one to the vote quantity corresponding to the first image information, and vote quantities of other image information remain unchanged.

In this embodiment of the present invention, the user may also change the vote that is already cast. Accordingly, after step 102, the following processing may be performed: receiving a second selection instruction corresponding to second image information; and sending a vote change request carrying an identifier of the second image information to the server.

The second image information may be any image information, except the first image information, in multiple pieces of the displayed image information. The second selection instruction is an instruction triggered when the user selects the second image information. The vote change request is a request for changing a vote that is already cast.

During implementation, when the user wants to change the vote that is already cast, the user may select the second image information instead of the first image information, and clicks a percentage icon displayed in the second image information, and in this case, the second selection instruction is triggered and generated. After receiving the second selection instruction, the first terminal generates the vote change request, adds the identifier of the second image information selected by the user to the vote change request, and sends the vote change request to the server. Meanwhile, after receiving the second selection instruction, the first terminal may locally cancel voting that is performed according to the voting request, and update the information about the vote quantity and a percentage of the vote quantity of local image information according to the second image information selected by the user, and specifically, the first terminal may subtract one from the vote quantity of the first image information, add one to the vote quantity of the second image information, and re-calculate a corresponding percentage of the vote quantity.

Accordingly, processing on the server side may be: receiving the vote change request sent by the first terminal, where the vote change request carries the identifier of the second image information; and canceling the updating that is performed on the stored information about the vote quantity according to the identifier carried in the voting request and of the first image information, and updating the stored information about the vote quantity according to the identifier carried in the vote change request and of the second image information.

During implementation, the server may subtract one from the vote quantity corresponding to the first image information, and add one to the vote quantity corresponding to the second image information.

This embodiment of the present invention further provides a process in which a terminal initiates voting to a server. Processing on the server side may be as follows:

Step 1: Receive a voting initiation request sent by a second terminal, where the voting initiation request carries voting indication information and multiple pieces of image information.

The second terminal may be the same terminal as the first terminal, or may be any other terminal.

During implementation, when a user wants to initiate picture voting, the user may click, on a corresponding webpage or application program, an option for initiating picture voting; in this case, the second terminal displays a window for picture voting, and the user may add a picture for voting, where the picture may be selected from locally stored pictures, or may be acquired in a manner of capturing or photographing. Meanwhile, the user may further enter corresponding voting indication information through a keyboard. Finally, the user may click a confirmation button, and in this case, the second terminal is triggered to send a voting initiation request to the server, and send corresponding voting indication information and a corresponding picture to the server. The server receives the corresponding image information and voting indication information.

Step 2: Store the voting indication information and multiple pieces of the image information, and record information about a vote quantity corresponding to each piece of the image information as zero.

Specifically, processing of storing image information may be as follows: for first image information, which satisfies a preset image parameter condition, in multiple pieces of the image information, storing the first image information; and for second image information, which does not satisfy the preset image parameter condition, in multiple pieces of the image information, adjusting the second image information to image information satisfying the preset image parameter condition, and storing the image information obtained through adjustment.

The preset image parameter condition may be a condition limiting the image parameter, such as a requirement on a ratio between length and width of an image.

During implementation, a size of a window displaying the image information (for example, the picture) may be fixed, for example, the display window is a square window having fixed side length, and the image parameter condition may be set to that the picture is required to be a square; and a picture not being a square may be cut to a square, for example, a square part in the middle of the picture may be cut by using width of the picture as the side, and the square picture is not cut. For a Graphics Interchange Format (GIF) picture, each picture may be cut according to the foregoing rule. Then, the square picture is zoomed to adapt to the size of the display window for storage.

In this embodiment of the present invention, multiple pieces of image information, and voting indication information are displayed, and when a first selection instruction corresponding to first image information is received, a voting request carrying an identifier of the first image information is sent to a server, so that the server updates stored information about a vote quantity corresponding to the image information according to the identifier carried in the voting request and of the first image information. In this way, image information is used as an option for voting, and a user may acquire more information from an image through a short browse, so as to improve accuracy of a selection result, thereby improving accuracy of statistics collection on network information.

Based on a same technical conception, an embodiment of the present invention further provides an apparatus for collecting statistics on network information. As shown in FIG. 3, the apparatus includes:

a display module 310, configured to display multiple pieces of image information and voting indication information; and

a sending module 320, configured to receive a first selection instruction corresponding to first image information, send a voting request carrying an identifier of the first image information to a server, and instruct, by using the voting request, the server to update, according to the identifier carried in the voting request and of the first image information, information that is stored in the server and about a vote quantity corresponding to the first image information.

The apparatus further includes a receiving module 330, configured to:

receive multiple pieces of the image information and the voting indication information that are sent by the server, and receive information that is sent by the server and about a vote quantity corresponding to each piece of the image information.

The display module 310 is configured to:

determine a percentage of the vote quantity corresponding to each piece of the image information according to the information about the vote quantity corresponding to each piece of the image information.

The display module 310 is further configured to:

set a circular percentage icon in each piece of the displayed image information according to a corresponding percentage of the vote quantity, and display the corresponding percentage of a vote quantity in the set percentage icon.

The sending module 320 is configured to:

when the first selection instruction triggered when a percentage icon corresponding to the first image information is clicked is received, send a voting request carrying an identifier of the first image information to the server.

The sending module 320 is further configured to:

after sending the voting request carrying the identifier of the first image information to the server, receive a second selection instruction corresponding to second image information; and

send a vote change request carrying an identifier of the second image information to the server.

In this embodiment of the present invention, multiple pieces of image information, and voting indication information are displayed, and when a first selection instruction corresponding to first image information is received, a voting request carrying an identifier of the first image information is sent to a server, so that the server updates stored information about a vote quantity corresponding to the image information according to the identifier carried in the voting request and of the first image information. In this way, image information is used as an option for voting, and a user may acquire more information from an image through a short browse, so as to improve accuracy of a selection result, thereby improving accuracy of statistics collection on network information.

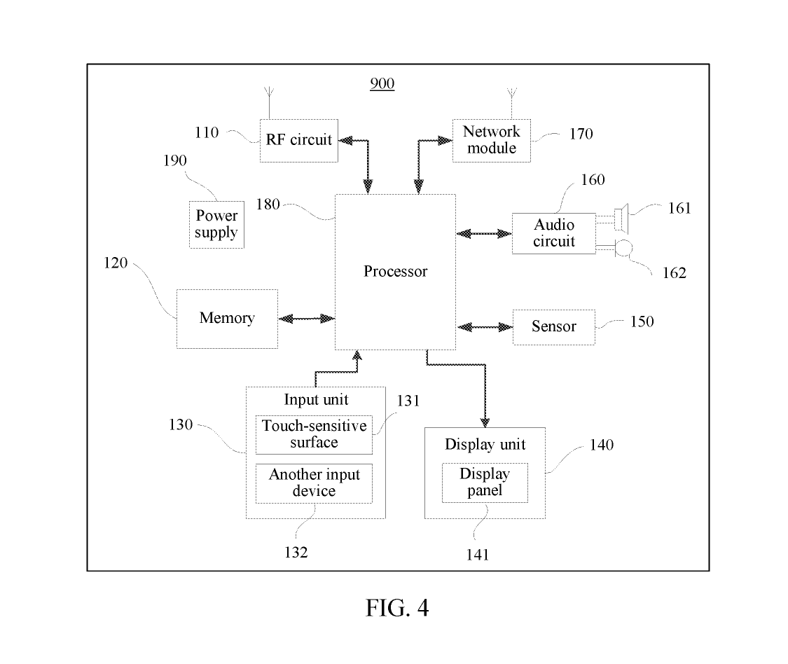

Refer to FIG. 4, which shows a schematic structural diagram of a terminal having a touch-sensitive surface according to an embodiment of the present invention. The terminal is configured to implement the method provided in the foregoing embodiment. Specifically:

The terminal 900 may include components such as a radio frequency (RF) circuit 110, a memory 120 including one or more computer readable storage media, an input unit 130, a display unit 140, a sensor 150, an audio circuit 160, a wireless fidelity (WiFi) module 170, a processor 180 including one or more processing cores, and a power supply 190. A person skilled in the art may understand that, a structure of the terminal shown in FIG. 4 does not constitute a limitation to the terminal, and the terminal may include more components or fewer components than those shown in the figure, or combine some components, or have a different component deployment.

The RF circuit 110 may be configured to receive and send information, or receive and send a signal in a conversation process, and specifically, after receiving downlink information of a base station, deliver the downlink information to one or more processors 180 for processing; in addition, send involved uplink data to the base station. Generally, the RF circuit 110 includes, but is not limited to, an antenna, at least one amplifier, a tuner, one or more oscillators, a subscriber identity module (SIM) card, a transceiver, a coupler, a low noise amplifier (LNA), and a duplexer, and the like. In addition, the RF circuit 110 may communicate with a network or another device through wireless communication. The wireless communication may use any communications standard or protocol, which includes, but is not limited to, a Global System of Mobile communication (GSM), a General Packet Radio Service (GPRS), Code Division Multiple Access (CDMA), Wideband Code Division Multiple Access (WCDMA), Long Term Evolution (LTE), an e-mail, and a Short Messaging Service (SMS).

The memory 120 may be configured to store a software program instruction, namely, the program instruction corresponding to the module 310 to the module 320 shown in FIG. 3. The processor 180 runs the software program instruction stored in the memory 10, to execute various function applications and data processing, for example, implement the method for collecting statistics on network information described in FIG. 1. The memory 120 may mainly include a program storage area and a data storage area, where the program storage area may store an operating system, an application program required by at least one function (such as a voice play function, and an image play function), and the like, and the data storage area may store data (such as audio data, and an address book), and the like that is created according to use of the terminal 900. In addition, the memory 120 may include a high speed random access memory, and may also include a non-volatile memory, such as at least one magnetic disk storage device, a flash memory, or another volatile solid-state storage device. Accordingly, the memory 120 may further include a memory controller, so that the processor 180 and the input unit 130 access the memory 120.

The input unit 130 may be configured to receive input digit or character information, and generate keyboard, mouse, joystick, optical, or track ball signal input related to the user setting and function control. Specifically, the input unit 130 may include a touch-sensitive surface 131 and another input device 132. The touch-sensitive surface 131 may also be referred to as a touch screen or a touch panel, and may collect a touch operation of a user on or near the touch-sensitive surface (such as an operation of a user on or near the touch-sensitive surface 131 by using any suitable object or attachment, such as a finger or a touch pen), and drive a corresponding connection apparatus according to a preset program. Optionally, the touch-sensitive surface 131 may include two parts: a touch detection apparatus and a touch controller. The touch detection apparatus detects a touch position of the user, detects a signal generated by the touch operation, and transfers the signal to the touch controller. The touch controller receives the touch information from the touch detection apparatus, converts the touch information into touch point coordinates, and sends the touch point coordinates to the processor 180. Moreover, the touch controller can receive and execute a command sent from the processor 180. In addition, the touch-sensitive surface 131 may be implemented by using various types, such as a resistive type, a capacitance type, an infrared type, and a surface acoustic wave type. In addition to the touch-sensitive surface 131, the input unit 130 may further include the another input device 132. Specifically, the another input device 132 may include, but is not limited to, one or more of a physical keyboard, a functional key (such as a volume control key or a switch key), a track ball, a mouse, and a joystick.

The display unit 140 may be configured to provide a display interface to display information input by the user or information provided for the user and various graphic user interfaces of the terminal 900, where the graphic user interfaces may be formed by a figure, text, an icon, a video, and any combination thereof. The display unit 140 may include a display panel 141. Optionally, the display panel 141 may be configured by using a liquid crystal display (LCD), an organic light-emitting diode (OLED), and the like. Further, the touch-sensitive surface 131 may cover the display panel 141. After detecting a touch operation on or near the touch-sensitive surface 131, the touch-sensitive surface 131 transfers the touch operation to the processor 180, so as to determine a type of a touch event. Then, the processor 180 provides corresponding visual output on the display panel 141 according to the type of the touch event. Although, in FIG. 4, the touch-sensitive surface 131 and the display panel 141 are used as two separate parts to implement input and output functions, in some embodiments, the touch-sensitive surface 131 and the display panel 141 may be integrated to implement the input and output functions.

The terminal 900 may further include at least one sensor 150, such as an optical sensor, a motion sensor, and another sensor. Specifically, the optical sensor may include an ambient light sensor and a proximity sensor. The ambient light sensor may adjust luminance of the display panel 141 according to brightness of the ambient light. The proximity sensor may switch off the display panel 141 and/or backlight when the terminal 900 is moved to the ear. As one type of motion sensor, a gravity acceleration sensor may detect magnitude of accelerations in various directions (generally on three axes), may detect magnitude and a direction of the gravity when static, and may be applied to an application that recognizes the attitude of the mobile phone (for example, switching between landscape orientation and portrait orientation, a related game, and magnetometer attitude calibration), a function related to vibration recognition (such as a pedometer and a knock). Other sensors, such as a gyroscope, a barometer, a hygrometer, a thermometer, and an infrared sensor, which may be configured in the terminal 900 are not further described herein.

The audio circuit 160, a loudspeaker 161, and a microphone 162 may provide an audio interface between the user and the terminal 900. The audio circuit 160 may transmit, to the loudspeaker 161, an electric signal that is converted from received audio data. The loudspeaker 161 converts the electric signal into a voice signal for outputting. On the other hand, the microphone 162 converts a collected voice signal into an electric signal. The audio circuit 160 receives the electric signal and converts the electric signal into audio data, and outputs the audio data to the processor 180 for processing. Then the processor 180 sends the audio data to another terminal by using the RF circuit 110, or outputs the audio data to the memory 120 for further processing. The audio circuit 160 may further include an earplug jack, so as to provide communication between a peripheral earphone and the terminal 900.

The terminal 900 may help, by using the WiFi module 170, a user to receive and send an e-mail, browse a webpage, and access stream media, and the like. The network module may be a WiFi module, where the WiFi module is a short distance wireless transmission technology. The terminal 900 provides wireless broadband Internet access for the user by using the WiFi module. Although FIG. 4 shows the network module 170, it may be understood that, the network module does not belong to a necessary constitution of the terminal 900, and can be ignored according to demands and within the scope of the essence of the present invention.

The processor 180 is a control center of the terminal 900, and is connected to each part of the terminal by using various interfaces and lines. By running or executing the software program and/or module stored in the memory 120, and invoking data stored in the memory 120, the processor executes various functions of the terminal 900 and processes data, thereby performing entire monitoring on the mobile phone. Optionally, the processor 180 may include one or more processing cores; and the processor 180 may integrate an application processor and a modem, where the application processor mainly processes an operating system, a user interface, and an application program and the like, and the modem mainly processes wireless communication. It may be understood that, the foregoing modem may also not be integrated into the processor 180.

The terminal 900 further includes a power supply 190 (such as a battery) for supplying power to each component. The power supply 190 may be logically connected to the processor 180 by using a power supply management system, thereby implementing functions, such as charging, discharging, and consumption management, by using the power supply management system. The power supply 190 may further include any component, such as one or more direct current or alternate current power supplies, a re-charging system, a power supply fault detection circuit, a power supply converter or an inverter, and a power supply state indicator.

Although not shown in the figure, the terminal 900 may further include a camera, and a Bluetooth module, and the like, which is not described herein again. Specifically, in this embodiment, the display unit of the terminal 900 is a touch screen display, and the terminal 900 further includes a memory, and one or more programs, where the one or more programs are stored in the memory 120, and one or more processors 180 are configured to execute an instruction included in the one or more programs and used for implementing the following instructions:

providing a display interface, to display multiple pieces of image information and voting indication information of each piece of the image information, each piece of image information corresponding to one identifier;

receiving, on the display interface, a first selection instruction corresponding to first image information;

sending a voting request carrying an identifier of the first image information to a server; and

instructing, by using the voting request, the server to update, according to the identifier carried in the voting request and of the first image information, information that is stored in the server and about a vote quantity corresponding to the first image information.

In this embodiment of the present invention, multiple pieces of image information, and voting indication information are displayed, and when a first selection instruction corresponding to first image information is received, a voting request carrying an identifier of the first image information is sent to a server, so that the server updates stored information about a vote quantity corresponding to the image information according to the identifier carried in the voting request and of the first image information. In this way, image information is used as an option for voting, and a user may acquire more information from an image through a short browse, so as to improve accuracy of a selection result, thereby improving accuracy of statistics collection on network information.

It should be noted that: when the apparatus for collecting statistic on network information provided in the foregoing embodiment collects statistics on network information, it is illustrated with an example of division of each function module. In the practical application, the function distribution may be finished by different function modules according to the requirements, that is, divide the internal structure of the equipment into different function modules, so as to finish all or part of the functions described apparatus. Besides, the apparatus for collecting statistics on network information provided in the foregoing embodiment and the embodiments of the method for collecting statistics on network information belong to one concept. For the specific implementation process, refer to the method embodiment, and no further details are provided herein.

The sequence numbers of the foregoing embodiments of the present invention are merely for the convenience of description, and do not imply the preference among the embodiments.

A person of ordinary skill in the art may understand that all or a part of the steps of the foregoing embodiments may be implemented by using hardware, or may be implemented by a program instructing relevant hardware. The program may be stored in a computer readable storage medium. The storage medium may be a read-only memory, a magnetic disk, or an optical disc.

The foregoing descriptions are merely exemplary embodiments of the present invention, but are not intended to limit the present disclosure. Any modification, equivalent replacement, or improvement made without departing from the spirit and principle of the present disclosure shall fall within the protection scope of the present disclosure.

What is claimed is:

1. A method for collecting statistics on network information, comprising:
at a computing device having one or more processors and a memory storing programs executed by the one or more processors:
providing a display interface, to display multiple pieces of image information and voting indication information of each piece of the image information, each piece of the image information corresponding to one identifier; and receiving, on the display interface, a first selection instruction corresponding to first image information;
sending a voting request carrying an identifier of the first image information to a server; and
instructing, by using the voting request, the server to update, according to the identifier carried in the voting request and of the first image information, information that is stored in the server and about a vote quantity corresponding to the first image information.

2. The method according to claim 1, further comprising: receiving multiple pieces of the image information and the voting indication information of each piece of the image information that are sent by the server.

3. The method according to claim 1, wherein the method further comprises: receiving information that is sent by the server and about the vote quantity corresponding to each piece of the image information; and
the displaying multiple pieces of image information and voting indication information of each piece of the image information comprises:
determining a percentage of the vote quantity corresponding to each piece of the image information according to the information about the vote quantity corresponding to each piece of the image information; and
displaying, on the display interface, multiple pieces of the image information, and the voting indication information and the percentage of the vote quantity of each piece of the image information.

4. The method according to claim 3, wherein the displaying, on the display interface, the percentage of the vote quantity of each piece of the image information, comprises:
setting a circular percentage icon in each piece of the displayed image information according to a corresponding percentage of the vote quantity, and displaying the percentage of the vote quantity corresponding to each piece of the displayed image information in the set percentage icon.

5. The method according to claim 4, wherein the receiving, on the display interface, a first selection instruction corresponding to first image information comprises:
receiving a click operation on a percentage icon corresponding to the first image information; and
triggering the first selection instruction according to the click operation.

6. The method according to claim 1, wherein after the sending a voting request carrying an identifier of the first image information to a server, the method further comprises:
receiving, on the display interface, a second selection instruction corresponding to second image information; and
sending a vote change request carrying an identifier of the second image information to the server.

7. An apparatus for collecting statistics on network information, comprising:
one or more processors;
a memory; and
one or more program modules stored in the memory and executed by the one or more processors, the one or more program modules comprising:
a display module, configured to provide a display interface, display multiple pieces of image information and voting indication information, each piece of the image information corresponding to one identifier; and
a sending module, configured to receive a first selection instruction corresponding to first image information, send a voting request carrying an identifier of the first image information to a server, and instruct, by using the voting request, the server to update, according to the identifier carried in the voting request and of the first image information, information that is stored in the server and about a vote quantity corresponding to the first image information.

8. The apparatus according to claim 7, further comprising a receiving module, configured to:
receive multiple pieces of the image information and voting indication information of each piece of the image information that are sent by the server.

9. The apparatus according to claim 7, further comprising a receiving module, configured to receive information that is sent by the server and about a vote quantity corresponding to each piece of the image information, wherein
the display module is configured to:
determine a percentage of the vote quantity corresponding to each piece of the image information according to the information about the vote quantity corresponding to each piece of the image information; and
display, on the display interface, multiple pieces of the image information, and the voting indication information and the percentage of the vote quantity of each piece of the image information.

10. The apparatus according to claim 9, wherein the display module is configured to:
set a circular percentage icon in each piece of the displayed image information according to a corresponding percentage of the vote quantity, and display the percentage of the vote quantity corresponding to each piece of the displayed image information in the set percentage icon.

11. The apparatus according to claim 10, the receiving, on the display interface, a first selection instruction corresponding to first image information refers to that: the sending module receives a click operation on a percentage icon corresponding to the first image information, and triggers the first selection instruction according to the click operation.

12. The apparatus according to claim 7, wherein the sending module is further configured to:
after sending the voting request carrying the identifier of the first image information to the server, receive, on the display interface, a second selection instruction corresponding to second image information; and
send a vote change request carrying an identifier of the second image information to the server.

13. A non-transitory computer readable storage medium having stored therein one or more instructions, which, when executed by a computing device, cause the computing device to:
providing a display interface, to display multiple pieces of image information and voting indication information of each piece of the image information, each piece of the image information corresponding to one identifier; and receiving, on the display interface, a first selection instruction corresponding to first image information;
sending a voting request carrying an identifier of the first image information to a server; and
instructing, by using the voting request, the server to update, according to the identifier carried in the voting request and of the first image information, information that is stored in the server and about a vote quantity corresponding to the first image information.
